(19) United States
(12) Patent Application Publication
(10) Pub. No.: US 2024/0359391 A1
(43) Pub. Date: Oct. 31, 2024

(54) MOLD INSERT, MOLD ASSEMBLY, AND SYSTEM

(71) Applicant: Plastipak Packaging, Inc., Plymouth, MI (US)

(72) Inventors: Marc A. Pedmo, Litchfield, OH (US); Michael Sainato, Wadsworth, OH (US); Jason Kuiper, Plymouth, MI (US)

(21) Appl. No.: 18/649,303

(22) Filed: Apr. 29, 2024

Related U.S. Application Data
(60) Provisional application No. 63/462,349, filed on Apr. 27, 2023.

(51) Int. Cl. B29C 49/48

(52) U.S. Cl. CPC B29C 49/487105; B29C 2049/4825; B29C 2049/4874

(57) ABSTRACT

A mold assembly for molding articles including a surface insert and a surface insert support configured to support at least a portion of the surface insert. In embodiments, the surface insert is configured to form at least a portion of a molded article and the surface insert has a thickness within a range of about 0.250 or 0.300 inches and about 1.500 inches or about 2.25 inches. The mold assembly may include a holding unit, and at least a portion of the surface insert and/or at least a portion of the surface insert support may be formed by additive manufacturing.

### CROSS-REFERENCE TO RELATED APPLICATIONS

This application claims the benefit of priority to U.S. Provisional Application Ser. No. 63/462,349, filed Apr. 27, 2023, which is fully incorporated herein by reference.

### TECHNICAL FIELD

The present disclosure generally relates to mold inserts and mold assemblies for molding, including printed mold inserts for blow molding articles, and related insert molding devices, methods, and systems.

### BACKGROUND

Blow molds are used to form articles, such as hollow plastic containers, by injection and/or blow molding. Typically, two or more mold portions of “halves” including molding cavities can combine to define an outer surface of an article, e.g., a container, to be produced therefrom. Such mold portions are commonly manufactured by subtractive processes out of metal blocks from which metal is removed to form desired cavities and article outer surfaces. However, molding machines and molds for manufacturing can be time very expensive and time-consuming to produce and/or modify.

Among other things, it is desirable to provide improved molds and molding systems, including those that can be used to form various articles, such as bottles or containers, in a more timely and/or cost-effective manner than often associated with traditional mold assemblies and manufacturing processes.

### SUMMARY

A mold assembly for molding articles may include a surface insert and a surface insert support configured to support at least a portion of the surface insert. In embodiments, the surface insert may be configured to form at least a portion of a molded article, the surface insert may have a thickness within a range of about 0.250 inches or about 0.300 inches and about 1.500 inches or 2.25 inches, the mold assembly may include a holding unit, and/or at least a portion of the surface insert and/or at least a portion of the surface insert support may be formed by additive manufacturing.

### BRIEF DESCRIPTION OF THE DRAWINGS

Embodiments of the disclosure will now be described, by way of example, with reference to the accompanying drawings, wherein:

FIG. 1 generally illustrates an exploded view of an embodiment of a mold assembly in accordance with aspects and teachings of the present disclosure;

FIG. 2A generally illustrates a perspective view of an embodiment of a surface insert;

FIG. 2B generally illustrates a front view of a surface insert such as shown in FIG. 2A;

FIG. 2C generally illustrates a rear view of a surface insert such as shown in FIG. 2A;

FIG. 2D generally illustrates a cross sectional view of a surface insert such as shown in FIG. 2C;

FIG. 3A generally illustrates a perspective view of an embodiment of a surface insert support;

FIG. 3B generally illustrates a front view of a surface insert support such as shown in FIG. 3A;

FIG. 3C generally illustrates a rear view of a surface insert support such as shown in FIG. 3A;

FIG. 3D generally illustrates a side view of a surface insert support such as shown in FIG. 3A;

FIG. 4A generally illustrates a perspective view of an embodiment of a fluid manifold;

FIG. 4B generally illustrates a top view of a fluid manifold as shown in FIG. 4A;

FIG. 4C generally illustrates a bottom view of a fluid manifold as shown in FIG. 4A;

FIG. 4D generally illustrates a front view of a fluid manifold as shown in FIG. 4A;

FIG. 5A generally illustrates a perspective view of an embodiment of a top plate;

FIG. 5B generally illustrates a perspective view of an embodiment of a fluid fitting;

FIG. 6 generally illustrates a rear perspective view of an embodiment of a mold assembly engaged with fluid fittings;

FIG. 7 generally illustrates a top view of an embodiment of a mold assembly engaged with fluid fittings;

FIG. 8 generally illustrates a front view of an embodiment of a mold assembly such as shown in FIG. 6;

FIG. 9 generally illustrates a side view of an embodiment of a mold assembly such as shown in FIG. 6;

FIG. 10A generally illustrate a front view of an embodiment of a portion of a surface insert;

FIG. 10B generally illustrates a side view of the surface insert shown in FIG. 10A;

FIG. 11A generally illustrates a front view of a portion of a surface insert;

FIG. 11B generally illustrates a side view, with hidden lines, of the portion of the surface insert shown in FIG. 11A;

FIG. 12A generally illustrates a front view of a portion of a thin surface insert;

FIG. 12B generally illustrates a right side view of the portion of the surface insert shown in FIG. 12A;

FIG. 12C generally illustrates a section view of the portion of the surface insert shown in FIG. 12A;

FIG. 13A generally illustrates a front view of a portion of a thin surface insert;

FIG. 13B generally illustrates a right side view of the portion of the surface insert shown in FIG. 13A;

FIG. 13C generally illustrates a section view of the portion of the surface insert shown in FIG. 13A;

FIG. 14 generally illustrates a front perspective view of an embodiment of a mold assembly in accordance with aspects and teachings of the present disclosure;

FIG. 15 generally illustrates an exploded view of an embodiment of a mold assembly such as shown in FIG. 14;

FIG. 16 generally illustrates a front perspective view of an embodiment of a surface insert;

FIG. 17 generally illustrates a rear perspective view of an embodiment of a surface insert;

FIG. 18 generally illustrates a side view of an embodiment of a surface insert;

FIG. 19 generally illustrates a front perspective view of an embodiment of a surface insert support;

FIG. 20 generally illustrates a rear perspective view of an embodiment of a surface insert support;

FIG. 21 generally illustrates a side view of an embodiment of a surface insert and a surface insert support;

FIG. 22 generally illustrates a rear perspective view of embodiment of a surface insert;

FIG. 23 generally illustrates a front perspective view of an embodiment of a surface insert.

FIG. 24 generally illustrates an exploded view of another embodiment of a mold assembly in accordance with aspects and teachings of the present disclosure;

FIG. 25A generally illustrates a perspective view of an embodiment of a surface insert support;

FIG. 25B generally illustrates a front view of a surface insert support such as shown in FIG. 25A;

FIG. 25C generally illustrates a top plan view of a surface insert support such as shown in FIG. 25A;

FIG. 25D generally illustrates a side view of a surface insert support such as shown in FIG. 25A;

FIG. 26A generally illustrates a perspective view of an embodiment of a first neck block insert;

FIG. 26B generally illustrates a front view of a first neck block insert such as shown in FIG. 26A;

FIG. 26C generally illustrates a top plan view of a first neck block insert such as shown in FIG. 26A;

FIG. 26D generally illustrates a side view of a first neck block insert such as shown in FIG. 26A;

FIG. 27A generally illustrates a perspective view of an embodiment of a second neck block insert;

FIG. 27B generally illustrates a front view of a second neck block insert such as shown in FIG. 27A;

FIG. 27C generally illustrates a top plan view of a second neck block insert such as shown in FIG. 27A;

FIG. 27D generally illustrates a side view of a second neck block insert such as shown in FIG. 27A;

FIG. 28 generally illustrates a perspective view of an embodiment of a first neck block insert and a second neck block insert;

FIG. 29A generally illustrates a perspective view of an embodiment of a support carrier;

FIG. 29B generally illustrates a front view of a support carrier such as shown in FIG. 29A;

FIG. 29C generally illustrates a rear view of a support carrier such as shown in FIG. 29A;

FIG. 29D generally illustrates a side view of a support carrier such as shown in FIG. 29A;

FIG. 29E generally illustrates a top plan view of a support carrier such as shown in FIG. 29A;

FIG. 30A generally illustrates a rear perspective view of another embodiment of a surface insert;

FIG. 30B generally illustrates a rear view of a surface insert such as shown in FIG. 30A;

FIG. 30C generally illustrates a front view of a surface insert such as shown in FIG. 30A;

FIG. 30D generally illustrates a side view of a surface insert such as shown in FIG. 30A;

FIG. 30E generally illustrates a top plan view of a surface insert such as shown in FIG. 30A;

FIG. 31 generally illustrates a rear perspective view of an embodiment of a surface insert of a type similar to that shown in FIG. 30A;

FIG. 32 generally illustrates a rear perspective view of the surface insert as shown in FIG. 31, viewed in transparent form to show internal cooling channels;

FIG. 33 generally illustrates a front perspective view of another embodiment of a mold assembly in accordance with aspects and teachings of the present disclosure;

FIG. 34A generally illustrates a cross-sectional view of a surface insert such as shown in FIG. 36A;

FIG. 34B generally illustrates enlarged view of a portion of the surface insert shown in FIG. 34A, and identifying a surface insert thickness and an overall surface insert thickness;

FIG. 35A generally illustrates a perspective view of a cross-section of a surface insert of the type shown in FIG. 34A;

FIG. 35B generally illustrates a perspective view of a cross-section of a surface insert of the type shown in FIG. 34A;

FIG. 36A generally illustrates a plan view of a surface insert; and

FIG. 36B generally illustrates a cross-sectional view of a surface insert such as shown in FIG. 36A.

### DETAILED DESCRIPTION

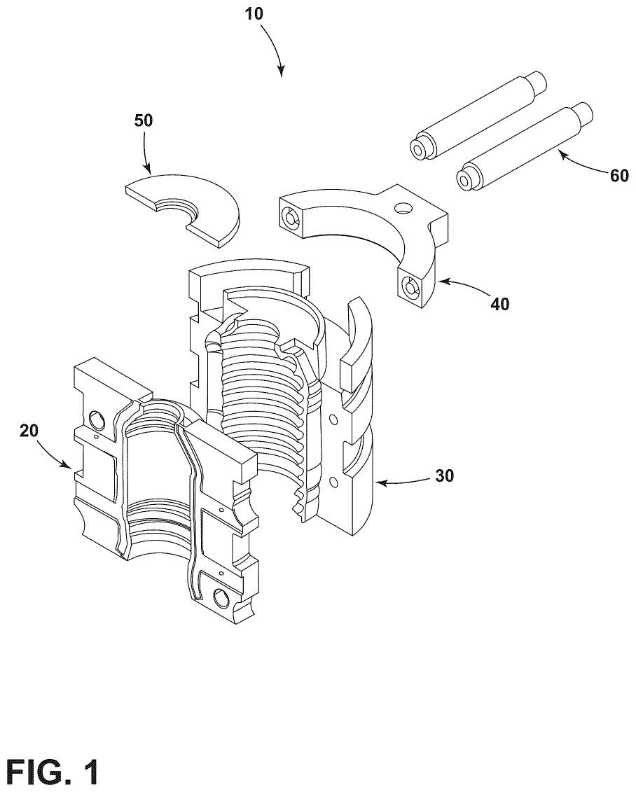

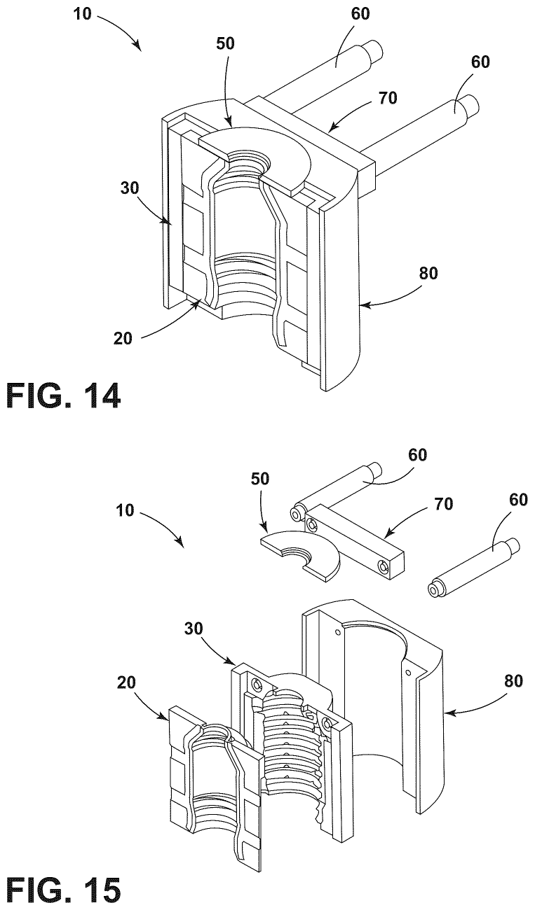

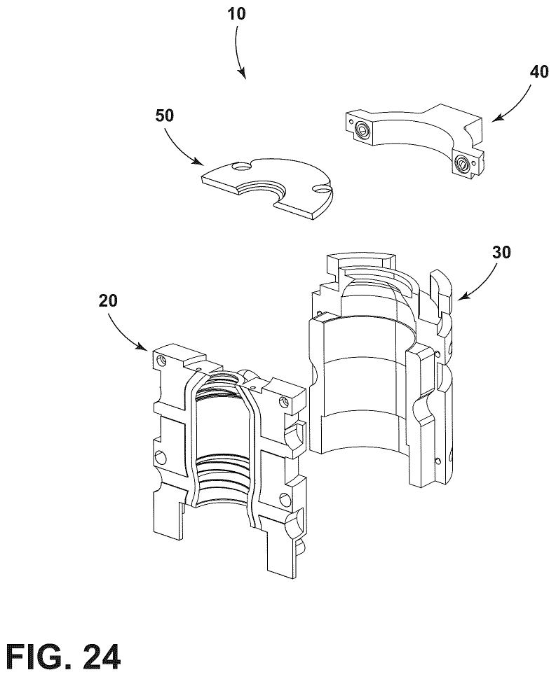

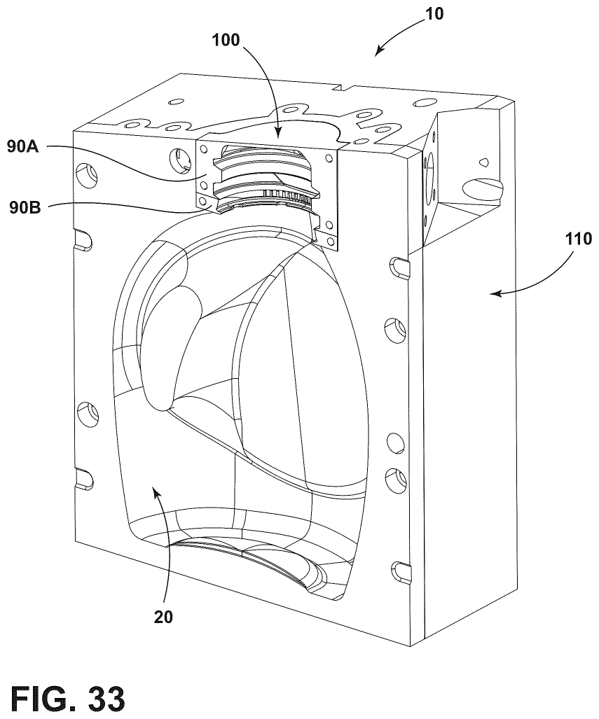

Embodiments of a mold assembly 10 are generally illustrated in FIG. 1 (in exploded form) and FIG. 14 (in assembled form). Without limitation, another embodiment of a mold assembly 10 with several similar elements/components is generally illustrated in FIG. 24 (in exploded form). Yet another embodiment of a mold assembly 10 is generally illustrated in FIG. 33 (in assembled form). Embodiments of a mold assembly 10 may include a surface insert 20, a surface insert support 30, a fluid manifold 40, a top plate 50, and one or more fluid fittings 60. The mold assembly may be further held by a mold holding unit (or “shell”), which may be of the type used in the industry to hold and/or operate mold halves.

In embodiments, a surface insert 20 may be comprised of material formed via additive manufacturing. In some applications, the surface insert 20 may be comprised of metal that is 3D printed or created by additive manufacturing techniques. Additive manufacturing techniques and processes may, for example, involve a layer-by-layer buildup of one or more materials to make a net or near net shaped article, which may be contrasted with subtractive manufacturing methods. Though “additive manufacturing” is an industry standard term (see. e.g., ASTM F2792), additive manufacturing may encompass various manufacturing and prototyping techniques known under a variety of names, including, without limitation, freeform fabrication, 3D printing, and rapid prototyping/tooling. Additive manufacturing techniques are capable of fabricating complex components from a wide variety of materials. Generally, freestanding articles can be fabricated using data models, including computer-aided design (CAD) models.

Some embodiments of a surface insert 20 may be comprised of material that is sintered, fused, or combined with metal powder. Without limitation, surface inserts 20 may be used in connection with blow molding, injection molding, rotational molding, or compression molding an article—such as, for example, bottles or containers.

With some embodiments, a surface insert 20 may, for example and without limitation, be comprised of aluminum, copper, aluminum bronze, stainless steel, or other metals suitable for a mold portion, or surface portion thereof.

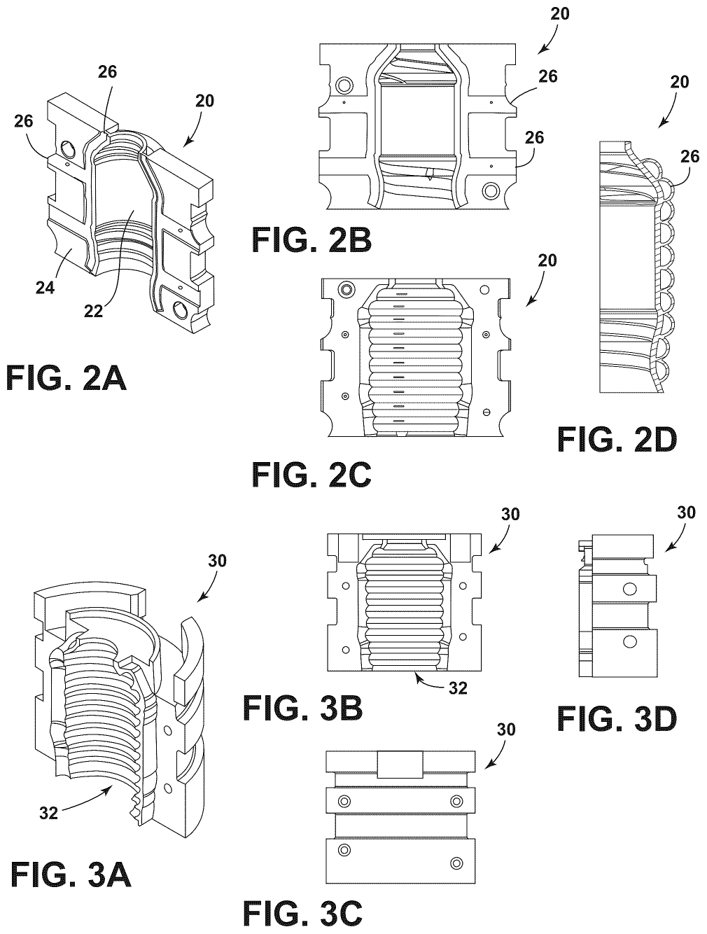

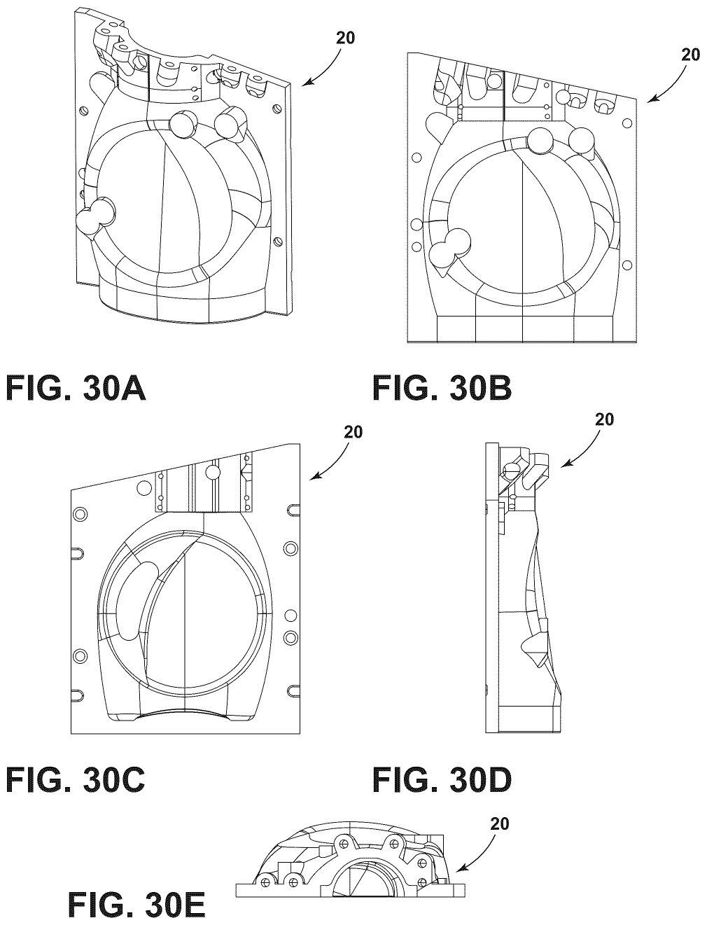

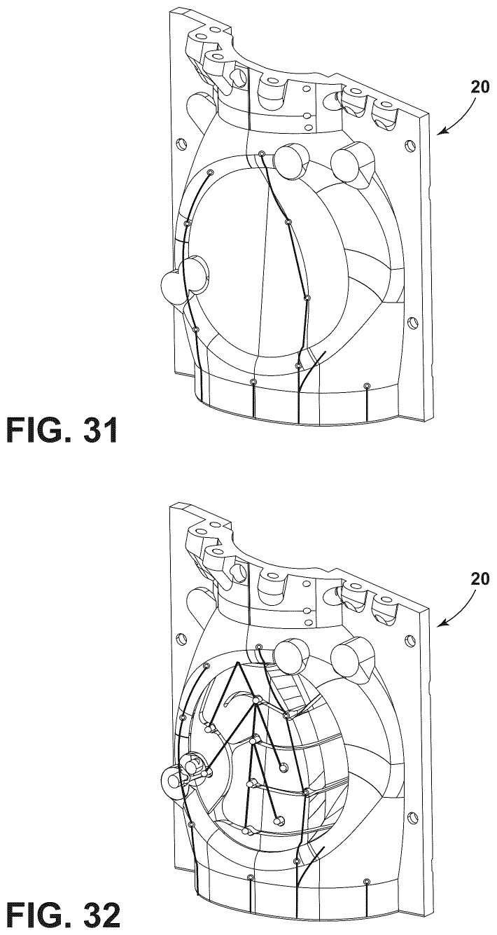

FIGS. 2A-2D generally illustrate views of an embodiment of a surface insert 20. FIG. 2A generally illustrates a front facing view of the surface insert 20. FIGS. 2B and 2C generally illustrate front and rear views, respectively, of the surface insert shown in FIG. 2A. FIG. 2D generally illustrates a side view of a surface insert such as shown in FIG. 2C. As shown, a surface insert 20 may include an article-forming surface (or portion) 22, an insert interfacing surface 24, and a one or more fluid channels 26. The one or more fluid channels 26 may comprise a plurality of cooling and/or heating channels, which may be configured about and/or around an article-forming surface (or portion) 22 and, may pass fluid to help regulate temperatures associated with portions of the mold assembly 10 and/or surface insert 20. The one or more fluid channels 26 may be interconnected and may, for example and without limitation, include vertical channel portions and/or horizontal channel portions. Without limitation, another embodiment of a surface insert 20 is generally illustrated in FIGS. 30A-30E.

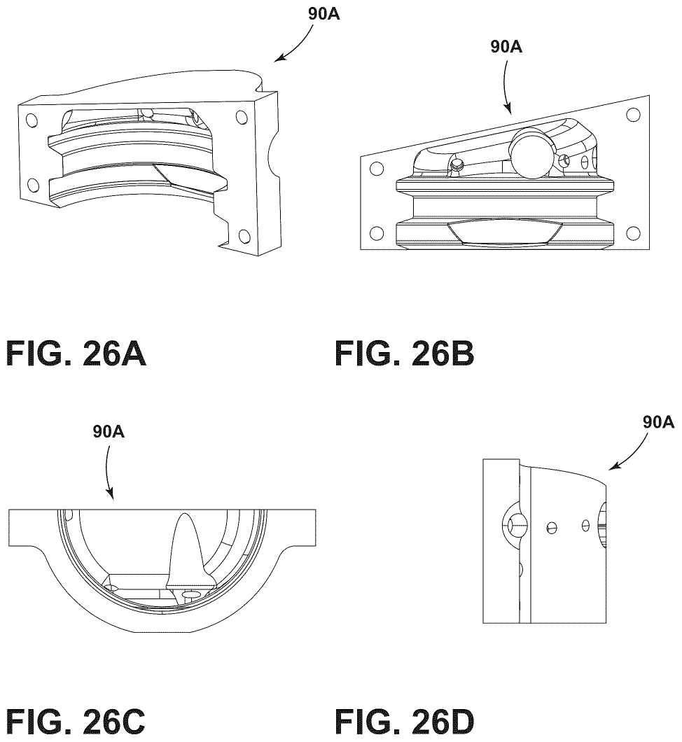

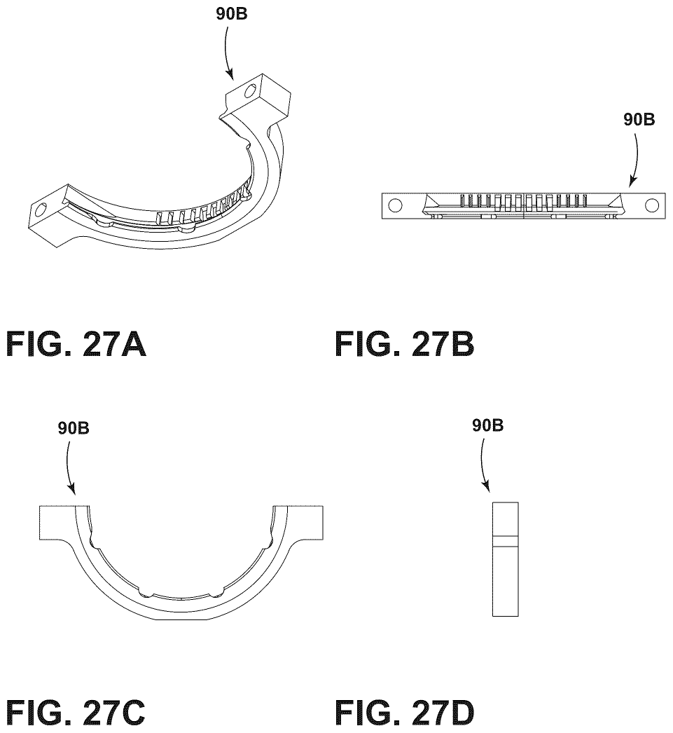

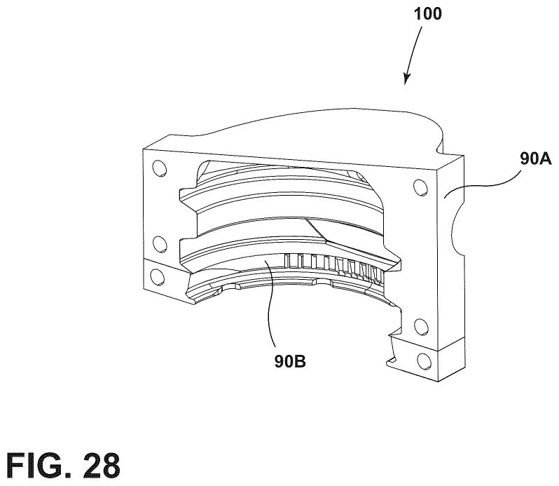

A surface insert 20 may include a neck block insert 100, which may form a neck and/or upper portion (e.g., blow dome profile) of an intended article to be molded. An embodiment of a neck block insert 100 is generally shown in FIG. 28. Embodiments of a neck block insert 100 may comprise a first neck block insert 90A and/or a second neck block insert 90B. For example and without limitation, an embodiment of a first neck block insert 90A is generally illustrated in FIGS. 26A-26D, and an embodiment of a second neck block insert 90B is generally illustrated in FIGS. 27A-27D. An embodiment of an assembled mold assembly 10 that includes a surface insert 20 with a first neck block insert 90A and a second neck block insert 90B is generally illustrated in FIG. 33. With embodiments, a neck block insert, which may comprise a first neck block insert and/or a second neck block insert, may be machined (whether together or separately) and then assembled, e.g., via additive manufacturing, with the remainder of the surface insert, and may be formed as a permanent component of the surface insert.

Embodiments of mold assemblies as disclosed may incorporate fluid (e.g., water) cooling or heating channels into a surface insert 20, a surface insert support 30, or combination thereof. Further, embodiments may alternatively or additionally incorporate a variety of cooling patterns, if cooling is employed, and/or heating rods, coils, wires, or combinations of heating channels, if heating is employed.

The article-forming surface (or portion) 22 of the illustrated surface insert 20 may be configured to form a portion of a bottle (e.g., an upper portion of a bottle). However, the disclosure is not limited to embodiments that form a portion of a bottle such as that illustrated. Rather, embodiments of surface inserts 20 associated with the disclosure may be configured to provide articles of almost limitless shapes, sizes, and configurations. Further, for example and without limitation, in embodiments the formed article may be comprised of various polymers, including polyethylene (PE), polypropylene (PP), high-density polyethylene (HDPE), low-density polyethylene (LDPE), and/or polyethylene terephthalate (PET).

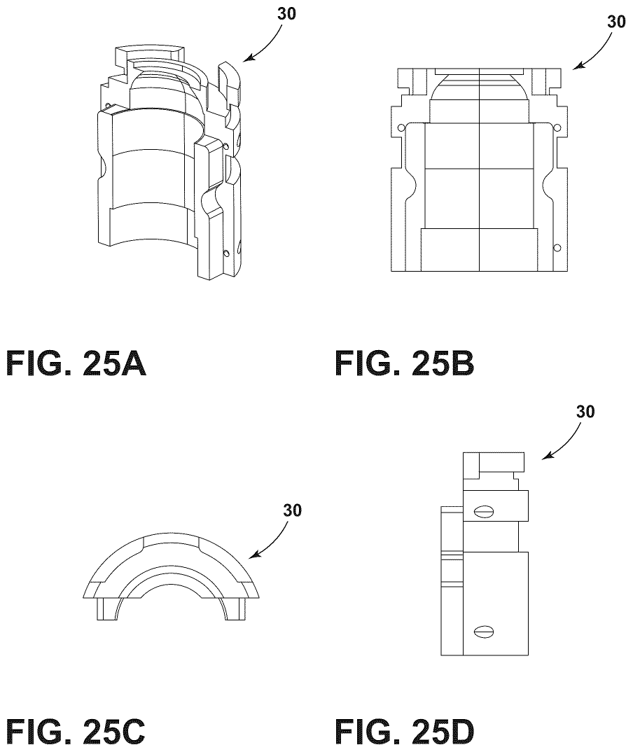

FIGS. 3A-3D generally illustrate views of an embodiment of a surface insert support 30. FIG. 3A generally illustrates a perspective view of an embodiment of a surface insert support 30. FIGS. 3B-3D generally illustrate views of a surface insert support such as shown in FIG. 3A. Referring to FIG. 3A, a surface insert support 30 may include a surface-insert-engaging portion 32, which may be configured to engage (e.g., mirror) all or a portion of a surface insert 20 (e.g., a rear portion of a surface insert 20, such as generally illustrated in FIG. 2C). Without limitation, another embodiment of a surface insert support 30 is generally illustrated in FIGS. 25A-25D.

In embodiments, a surface insert support 30 may be comprised of various materials, which may or may not comprise the same or similar materials as a surface insert 20. In embodiments, a surface insert support 30 may be comprised of material formed via additive manufacturing and/or various other mold component manufacturing techniques or processes. In embodiments, the surface insert support 30 may be comprised of a metal, a polymer, a combination of materials (including metals and polymers), or other materials suitable for mold related applications and environments.

In embodiments, the surface insert 20 and the surface insert support 30 may each be unitary or multi-part, and may be cylindrical, square, rectangular or any geometric shape.

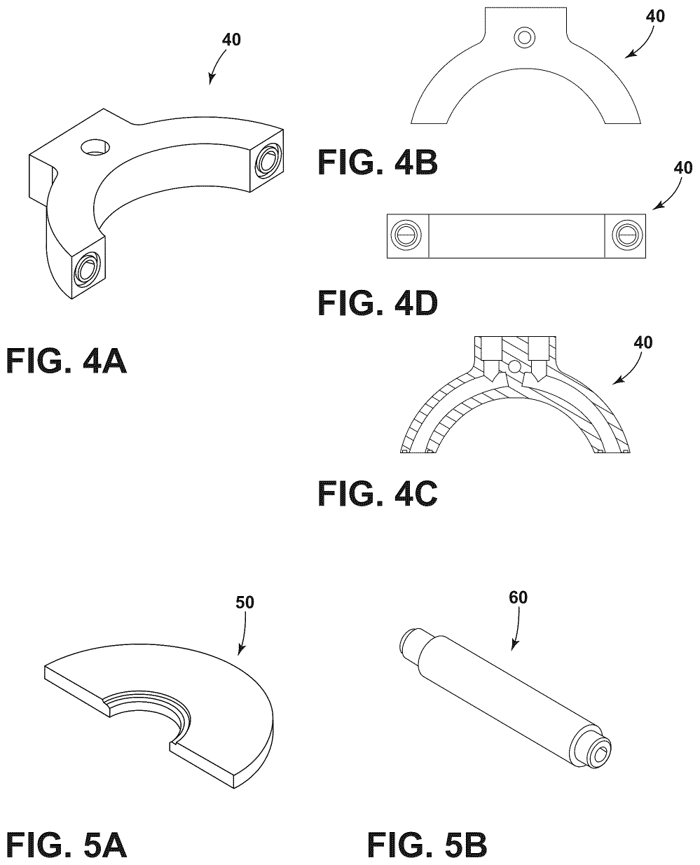

FIG. 4A generally illustrates an embodiment of a fluid manifold 40. FIGS. 4B-4D generally illustrate top, bottom, and side views, respectively, of a fluid manifold 40 such as generally shown in FIG. 4A. In embodiments a fluid manifold 40 may be configured to engage or interact with a surface insert support 30 and/or a surface insert 20. A fluid manifold may, among other things and without limitation, be configured to pass or direct a fluid (e.g., water or other cooling fluid) to one or more passages associated with a surface insert 20 and/or a surface insert support 30.

Embodiments of a mold assembly 10 may additionally include a top plate 50 (such as generally illustrated in FIG. 5A) and/or one or more fluid fittings 60 (such as generally illustrated in FIG. 5B).

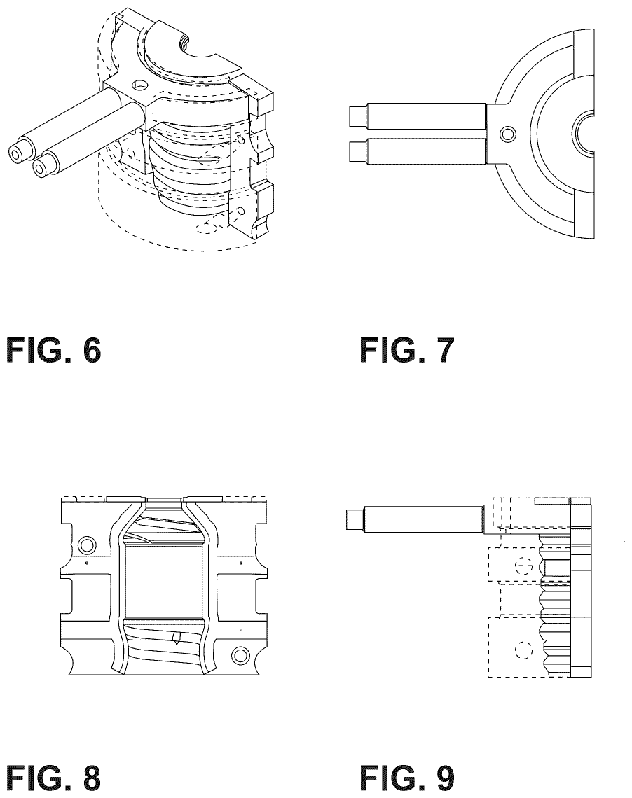

FIG. 6 generally illustrates a rear perspective view of an embodiment of a mold assembly 10 that generally illustrates the components such as shown in FIG. 1 in an assembled configuration. FIGS. 7, 8, and 9 generally illustrate top, front, and side views, respectively, of an embodiment of a mold assembly, such as generally shown in FIG. 6.

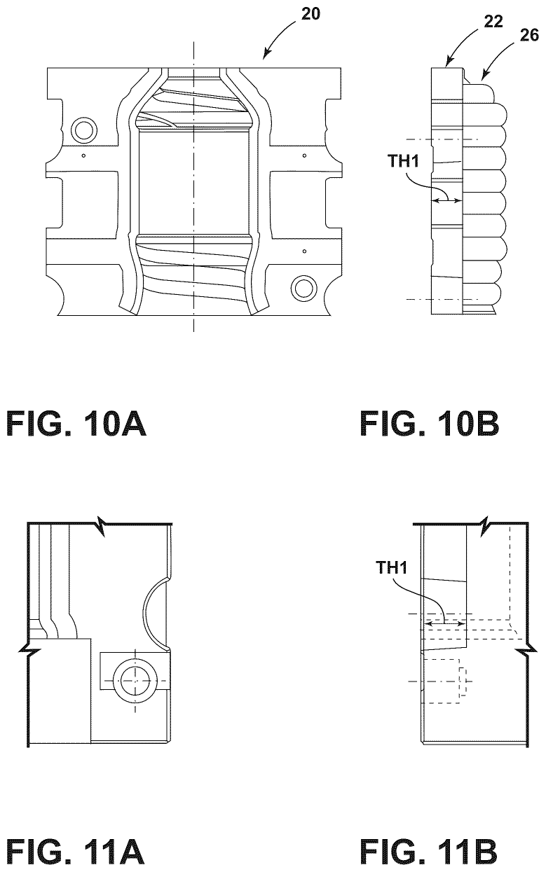

FIGS. 10A and 10B generally illustrate front and side views, respectively, of an embodiment of a portion of a surface insert 20. As generally illustrated in FIG. 10B, an article-forming portion 22 of a surface insert 20 may have a thickness (or depth). In embodiments, a surface insert thickness (or depth) TH1 may, for example and without limitation, be about 0.619 inches (15.7226 mm). FIGS. 11A and 11B generally illustrate front and side (with hidden lines) views, respectively, of a portion of a surface insert 20. A surface insert thickness (or depth) TH1 associated with a portion of the surface insert 20 is generally depicted in FIG. 11B. Without limitation, in embodiments (and as generally illustrated in FIGS. 11A and 11B) a surface insert thickness TH1 may generally match a depth of a tab pocket in a surface insert.

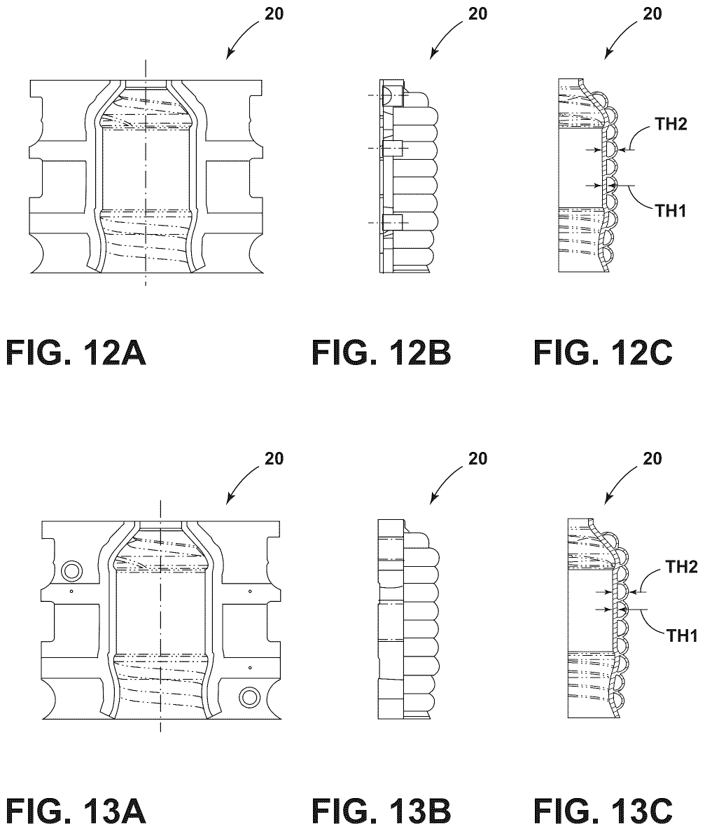

FIGS. 12A-12C generally illustrate front, right side, and section views, respectively, of an embodiment of a portion of a surface insert 20 (which may be characterized as a thin surface insert). For example and without limitation, a surface insert such as shown in FIG. 12A may be configured to have an insert volume of about 6.180 in³ and a mold surface area of about 16.178 in².

Mold assemblies in accordance with aspects or teachings of the present disclosure may exhibit or demonstrate reduced or improved dimensions and/or ratios. For example, embodiments may have reduced or improved ratios of an insert volume (e.g., volume of the whole part) to an insert molding surface area (e.g., a surface area associated with a portion of a part to be formed by a surface insert). With embodiments, ratios of an insert volume to an insert molding surface area may be less than 1.0. With other embodiments an insert volume to an insert molding surface area ratio may be (a) less than about 0.75, (b) less than about 0.73, less than about 0.66, or less than about 0.382.

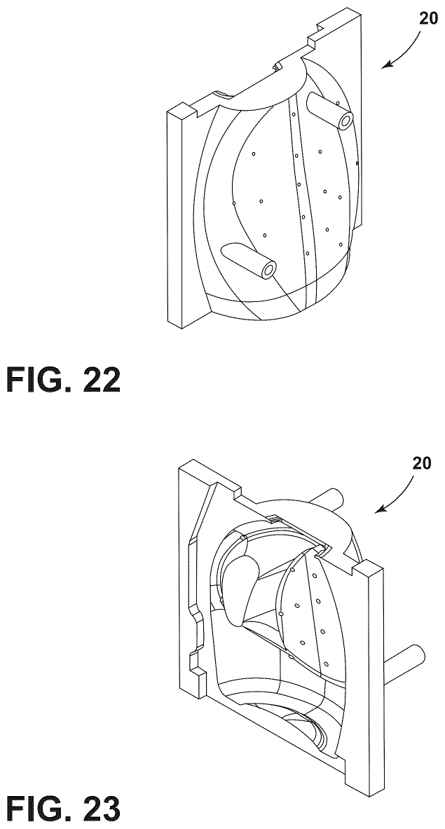

For example and without limitation, the following table presents data associated with some non-limiting insert volume to surface area ratios for several different embodiment of surface inserts.

| | Insert V | Surface A | Ratio |
|---|---|---|---|
| FIG. 12A Thin 10 oz Insert | 6.18 | 16.178 | 0.382 |
| FIG. 13A Thick 10 oz insert | 10.641 | 16.178 | 0.657745 |
| FIG. 22 96 oz HDPE Insert #1 | 67.622 | 94.638 | 0.714533 |
| Not Shown 96 oz HDPE Insert #2 | 70.385 | 96.471 | 0.729597 |

FIGS. 13A-13C generally illustrate front, right side, and section views, respectively, of an embodiment of a portion of a surface insert 20 (which may be characterized as a thick or thicker surface insert). For example and without limitation, a surface insert such as shown in FIG. 13A may be configured to have an insert volume of about 10.641 in³ in connection with a mold surface area of about 16.178 in². In embodiments, as generally illustrated in the section views, such as shown in FIGS. 12C and 13C, a surface insert 20 may have a surface insert thickness TH1, such as generally shown that, for example and without limitation, may be about 0.125 inches (3.175 mm), and may—with the inclusion of fluid channels—may have a thickness, e.g., and overall surface insert thickness (or depth) TH2, that is about 0.375 inches (9.525 mm). With some embodiments, a surface insert thickness (or depth) TH1 may range from about 0.075 inches (1.905 mm) to about 0.200 inches (5.08 mm) and/or an overall surface insert thickness (or depth) TH2 may range from about 0.250 inches (6.35 mm) to about 0.750 inches (19.05 mm). However, it is noted that such dimensions included in connection with the figures are exemplary only, and persons of skill in the art will understand that such dimensions may be modified for various embodiments and applications.

Another embodiment of a mold assembly 10 is illustrated in FIG. 14, and is generally shown in exploded view form in FIG. 15. As illustrated, a mold assembly 10 may include a surface insert 20, a surface insert support 30, a fluid manifold 40, a top plate 50, one or more fluid fittings 60, a fluid adapter block 70, and a support carrier 80. For ease of reference, various components/elements associated with the embodiments of an assembly 10 shown in FIGS. 14 and 15 that are the same or similar to components/elements associated with the embodiment of an assembly shown in FIG. 1 include similar numbering.

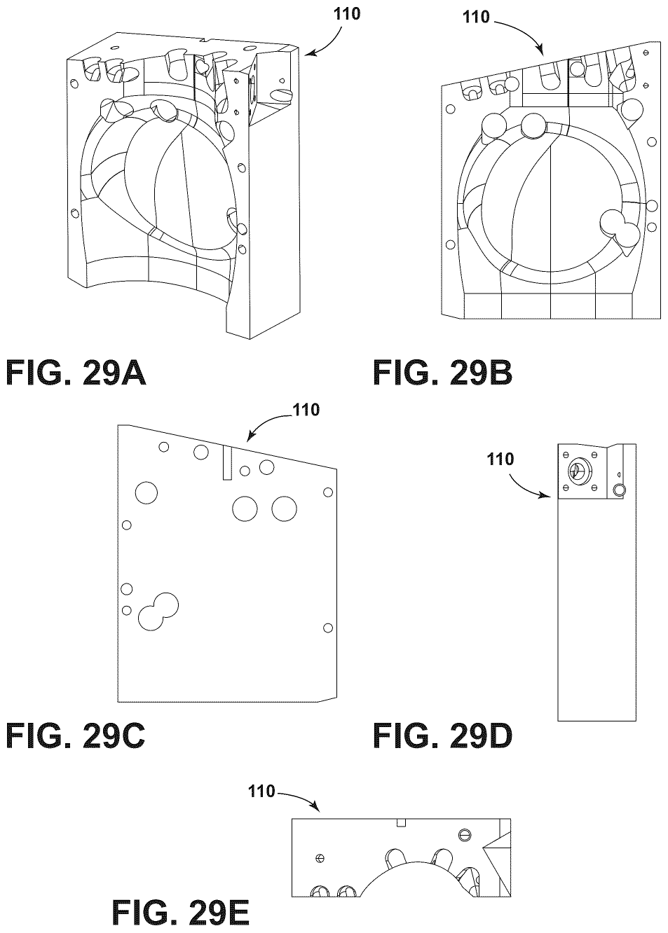

As generally illustrated in the embodiment shown in FIGS. 14 and 15, a support carrier 80 may be configured to hold or retain all or a portion of a surface insert support 30. A fluid adapter block 70 may be configured to connect to or engage one or more fluid fittings 60, and to connect to or engage the support carrier 80. The components may be configured such that fluid (e.g., water) may be transmitted from a fluid fitting 60 through the support carrier 80 and supplied to the surface insert support 30. A support carrier 80 may, inter alia, carry or provide significant structure and/or support to the assembly and molding operation, such that an associated surface insert support 30 may require less material and/or an associated surface insert support 30 may have more structural nuances or intricacies. A support carrier 80 may comprise, without limitation, a support material such as a polymer, a metal, or a combination of a polymer and a metal. Depending on the application and material selected, such support materials may, for example and without limitation, be machined, fused, extruded, or cast. Without limitation, an embodiment of an adapter 110 is generally illustrated in FIGS. 29A-29E. An adapter 110 may be comprised of a polymer; may be used in connection with a surface insert, and/or may serve the function of a surface insert support, a support carrier, or a combination of both. With embodiments, a polymer adapter, such as generally illustrated, may be utilized in connection with an additive manufactured extrusion mold.

With some embodiments of a mold assembly, fluid supplied to the surface insert support 30 may be further supplied to one or more fluid channels (e.g., fluid channels 26) disposed in or associated with the surface insert 20. With other embodiments, a portion of the surface insert 20 and an adjacent portion of a surface insert support 30 may be configured such that, when the surface insert and the surface insert support are connected or engaged, a fluid channel may be provided or created via combination of one or more portions of the surface insert 20 interfacing with one or more portions of the surface insert support 30. For example and without limitation, portions (e.g., generally semi-circular formations) of a surface insert 20 may engage with portions (e.g., generally semi-circular formations) of a surface insert support 30 to provide fluid channels (e.g., generally circular fluid channels) between the two clements/components, and which could supply or distribute fluid to various portions of the surface insert 20 to further molding.

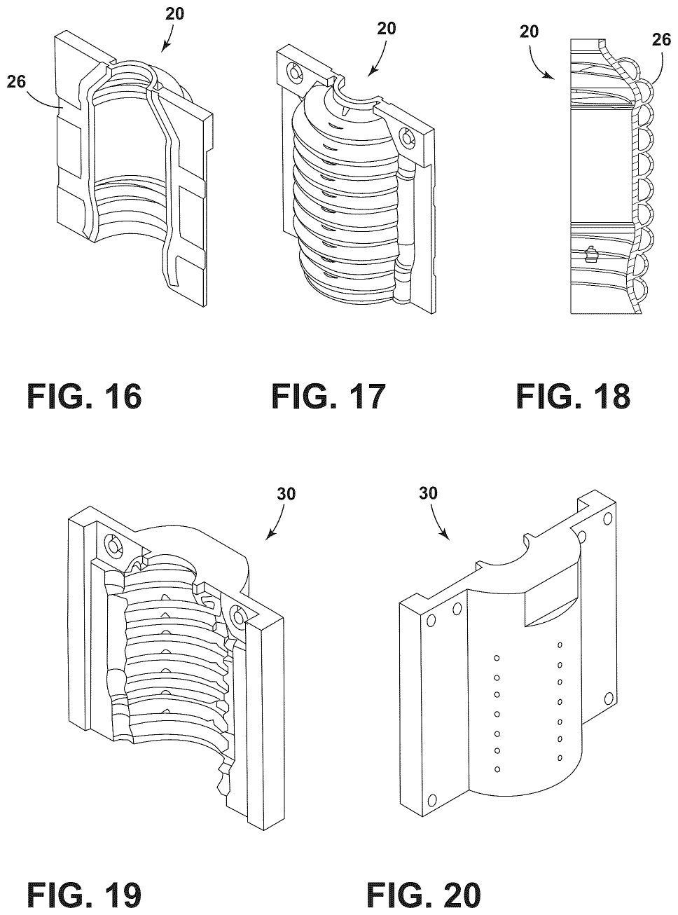

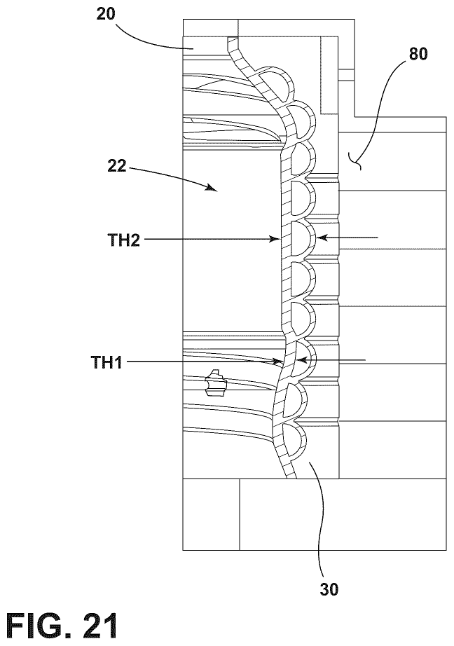

FIGS. 16, 17, and 18 generally illustrate front perspective, rear perspective, and side vicws, respectively, of an embodiment of a surface insert 20 such as generally shown in FIG. 14. FIGS. 19, 20, and 21 generally illustrate front perspective, rear perspective, and side views, respectively, of an embodiment of a surface insert support 30 such as generally shown in FIG. 14. FIG. 21 shows a molding surface—e.g., article-forming surface 22—and illustrates an overall surface insert thickness (e.g., TH2) and surface inner thickness (e.g., TH1, which essentially excludes added thickness of associated fluid channels). For example and without limitation, an overall surface insert thickness TH2 may range from about 0.250 inches (6.35 mm) to about 1.500 inches (38.1 mm). However, with some embodiments, an overall surface insert thickness TH2, at least in portions of the surface insert 20 (for example, behind a handle, if present), may exceed 1.500 inches and may range up to 2.25 inches (57.15 mm). With some embodiments, an overall surface insert thickness TH2 of the surface insert may be less than about 2.25 inches (57.15 mm). Further, a surface insert thickness TH1, such as generally illustrated, may range from about 0.030 inches (0.762 mm) to about 0.500 inches (12.7 mm). Some embodiments of surface inserts have a minimum surface insert thickness TH1 of 0.03 inches (0.762 mm) and a maximum of 0.500 inches (12.7 mm) provided between a molding surface portion of a surface insert 20 and a supporting surface of a surface insert support 30 or a fluid (e.g., cooling/heating) channel.

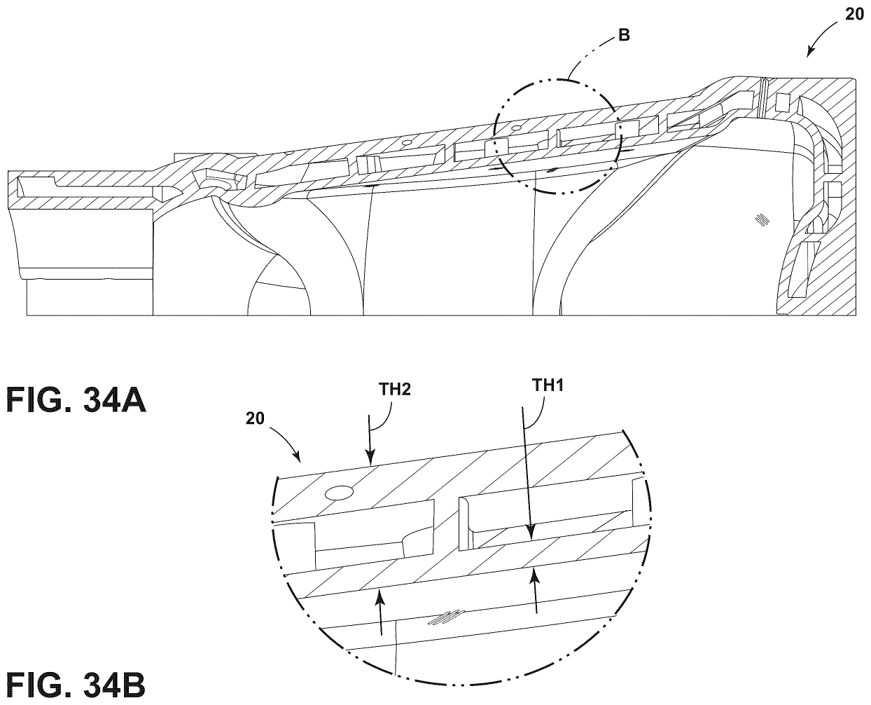

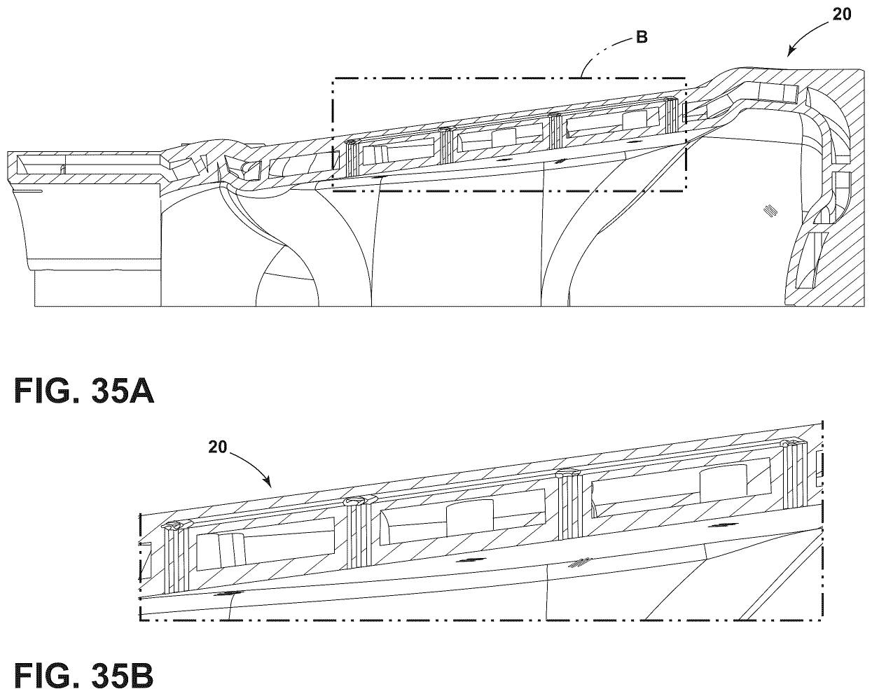

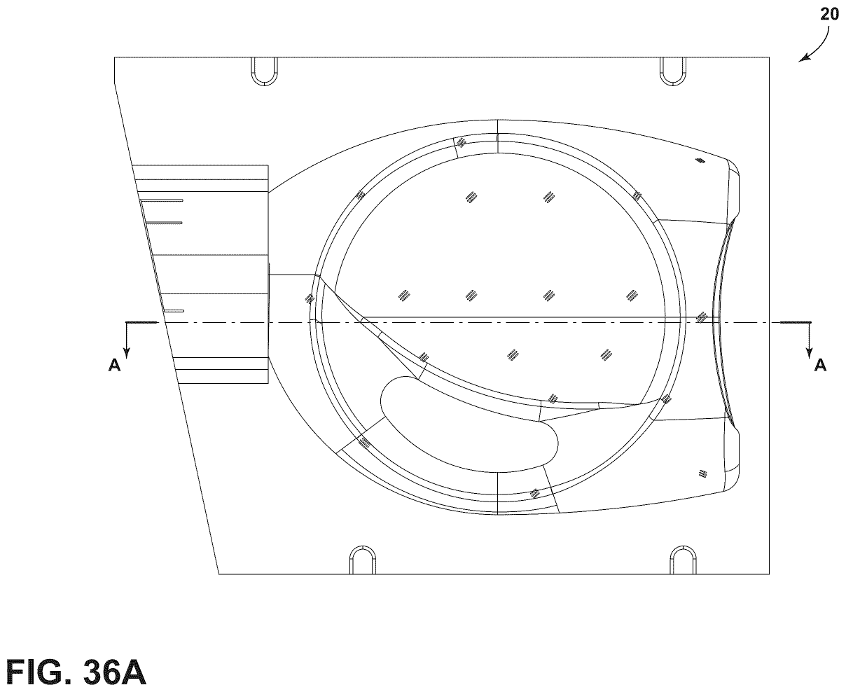

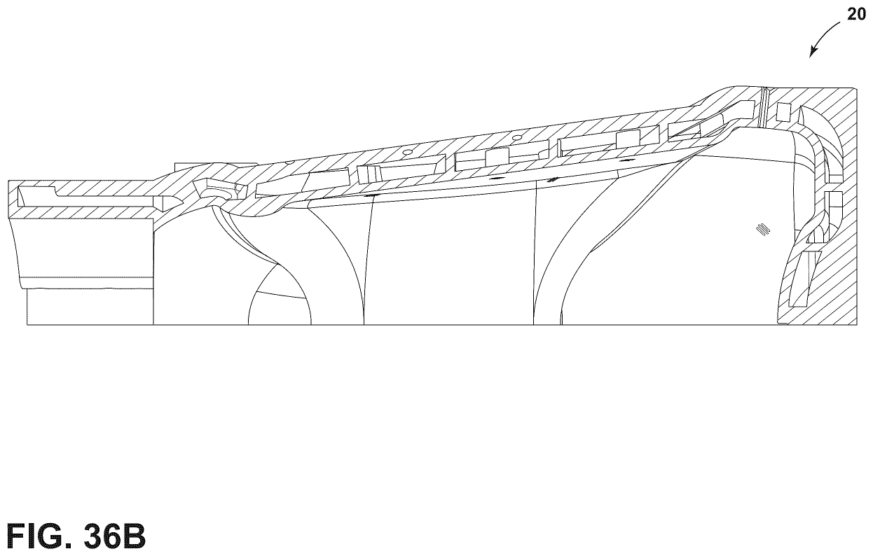

FIG. 22 generally illustrates a rear perspective view of another embodiment of a surface insert 20; and FIG. 23 generally illustrates a front perspective view of an embodiment of a surface insert 20 such as shown in FIG. 22. As generally illustrated, the surface insert may be configured to form a portion of an article that may include a handle or handle portion. Without limitation, the embodiment of a surface insert may be used in connection with HDPE articles, such as HDPE bottles or containers, including those with features such as handles. FIG. 36A illustrates an embodiment of a surface insert 20 with a handle portion. Such a surface insert (or similar surface inserts) may be utilized, for example and without limitation, in an extrusion mold for article comprising HDPE. FIGS. 34A and 36B depict a cross-section view of the surface insert 20 (taken along A-A) in FIG. 36A. FIG. 34B is an enlarged view of a portion of the insert shown in FIG. 34A. FIG. 34B generally illustrates a surface insert thickness TH1 and an overall surface insert thickness TH2 in connection with the surface insert 20. FIGS. 35A and 35B generally illustrate a perspective view of a cross-section of a surface insert 20, of the type shown in FIG. 34A, and further illustrating fluid channels.

With embodiments, a surface insert, surface insert support, and/or support carrier may include cooling channels and/or heating channels in the surface insert or a combination of the surface insert and an associated surface insert support and/or support carrier. With some embodiments, a maximum total distance from a surface area of a molded part to a surface insert support encompassing fluid channel (e.g., water channel) for cooling and/or heating channel will be about 1.500 inches (38.1 mm) or less.

Additionally, with some embodiments, a thickness associated with a surface insert may closely match a depth of a tab pocket on a surface insert support. Some embodiments may involve “wings” formed via additive manufacturing. With such embodiments, portions of the wings may be made relatively thicker, compared other portions of the wing, to facilitate mating with metal.

Embodiments of the disclosure can allow for mold assemblies having a comparatively thin, cheap surface insert that can be rapidly formed of a metal via additive manufacturing. Such surface inserts may be rapidly interchanged, for example, for rapid prototyping. Further, as disclosed, the surface insert may be 3D printed of a metal and the backing thereof, e.g., a surface insert support, may be printed out of a polymer or created via simplified machining.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such elements. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are intended to be inclusive unless such a construction would be illogical.

While examples of dimensions of certain components may be described herein, such dimensions are provided as non-limiting examples and the components may have other dimensions.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

It is intended that all matter contained in the above description or shown in the accompanying drawings shall be interpreted as illustrative only and not limiting. Changes in detail or structure may be made without departing from the present disclosure.

What is claimed is:

1. A mold assembly for molding articles, comprising:
a surface insert configured to form a least a portion of a molded article, the surface insert having an overall surface insert thickness within a range of about 0.250 inches to about 1.500 inches; and
a surface insert support, the surface insert support configured to support at least a portion of the surface insert;
wherein at least a portion of the surface insert and/or at least a portion of the surface insert support are formed by additive manufacturing.

2. The mold assembly of claim 1, wherein the surface insert is comprised of metal and is formed by additive manufacturing.

3. The mold assembly of claim 1, wherein the surface insert is comprised of metal and is formed by 3D printing.

4. The mold assembly of claim 1, wherein the surface insert is comprised of aluminum, copper, aluminum bronze, or stainless steel.

5. The mold assembly of claim 1, wherein the surface insert is comprised of material that is sintered, fused, or combined with metal powder.

6. The mold assembly of claim 1, wherein the surface insert includes an article-forming surface or portion, an insert interfacing surface, and one or more fluid channels.

7. The mold assembly of claim 6, wherein the one or more fluid channels include a plurality of cooling and/or heating channels configured about and/or around the article-forming surface or portion.

8. The mold assembly of claim 6, wherein the one or more fluid channels are interconnected.

9. The mold assembly of claim 6, wherein the article-forming surface or portion is configured to form a portion of a bottle.

10. The mold assembly of claim 1, includes one or more fluid cooling or heating channels included in the surface insert, the surface insert support, or a combination of the surface insert and the surface insert support.

11. The mold assembly of claim 1, including one or more heating channels and further including one or more of heating rods, coils, and wires.

12. The mold assembly of claim 1, wherein an article formed by the mold assembly is comprised of a polymer.

13. The mold assembly of claim 1, wherein an article formed by the mold assembly is comprised of polyethylene (PE), polypropylene (PP), high-density polyethylene (HDPE), low-density polyethylene (LDPE), and/or polyethylene terephthalate (PET).

14. The mold assembly of claim 1, wherein the surface insert includes a surface-insert-engaging portion configured to engage all or a portion of the surface insert.

15. The mold assembly of claim 1, wherein the surface insert and the surface insert support are comprised of the same material.

16. The mold assembly of claim 1, wherein the surface insert support is comprised of a metal.

17. The mold assembly of claim 1, wherein the surface insert support is comprised of a polymer.

18. The mold assembly of claim 1, wherein an article-forming portion of the surface insert has a thickness in the range of from about 0.030 inches (0.762 mm) to about 0.500 inches (12.7 mm).

19. The mold assembly of claim 1, wherein an article-forming portion of the surface insert has a thickness substantially equal to a depth of a tab pocket in the surface insert.

20. The mold assembly of claim 1, wherein a ratio of an insert volume for a whole part to an insert molding surface area for a portion of the part formed by the surface insert is less than 1.0.

21. The mold assembly of claim 1, wherein a ratio of an insert volume for a whole part to an insert molding surface area for a portion of the part formed by the surface insert is less than 0.75.

22. The mold assembly of claim 1, wherein a ratio of an insert volume for a whole part to an insert molding surface area for a portion of the part formed by the surface insert is less than 0.382.

23. The mold assembly of claim 1, wherein the surface insert includes fluid channels, has an overall thickness that ranges from about 0.250 inches (6.35 mm) to about 0.750 inches (19.05 mm), and has an article-forming surface thickness that ranges from about 0.075 inches (1.905 mm) to about 0.200 inches (5.08 mm).

24. The mold assembly of claim 1, including a support carrier configured to hold or retain at least a portion of the surface insert support.

25. The mold assembly of claim 1, wherein the surface insert includes a neck block insert.

26. The mold assembly of claim 25, wherein the neck block insert comprises a first neck block insert and a second neck block insert.

27. The mold assembly of claim 1, wherein a portion of the surface insert and an adjacent interfacing portion of the surface insert support, when connected or engaged, form a fluid channel.

28. The mold assembly of claim 1, wherein the surface insert includes a wing in which portions adapted to mate with metal are relatively thicker than other portions of the wing.

29. A mold assembly for molding articles, comprising:
a surface insert configured to form a least a portion of a molded article, the surface insert having an overall surface insert thickness that is less than 2.25 inches; and
a surface insert support, the surface insert support configured to support at least a portion of the surface insert;
wherein at least a portion of the surface insert and/or at least a portion of the surface insert support are formed by additive manufacturing; and a ratio of an insert volume for a whole part to an insert molding surface area for a portion of the part formed by the surface insert is less than 1.0.
